(19) United States
(12) Patent Application Publication
(10) Pub. No.: US 2013/0122246 A1
(43) Pub. Date: May 16, 2013

(54) STRUCTURAL MEMBERS AND METHODS OF MAKING A STRUCTURAL JOINT

(71) Applicants: Elisabeth J. Berger, Farmington Hills, MI (US); Bhavesh Shah, Troy, MI (US)

(72) Inventors: Elisabeth J. Berger, Farmington Hills, MI (US); Bhavesh Shah, Troy, MI (US)

(73) Assignee: GM GLOBAL TECHNOLOGY OPERATIONS LLC, Detroit, MI (US)

(21) Appl. No.: 13/558,142

(22) Filed: Jul. 25, 2012

Related U.S. Application Data
(60) Provisional application No. 61/558,792, filed on Nov. 11, 2011.

(51) Int. Cl. B32B 7/08; B32B 37/02; B32B 7/10; B32B 37/04

(52) U.S. Cl. 428/119; 156/92; 156/73.5; 156/73.1

(57) ABSTRACT

Structural members are disclosed herein. An example of the structural member includes a primary thermoplastic composite structure and a secondary panel having opposed sides and an aperture extending from one of the opposed sides to another of the opposed sides. The secondary panel is formed of metal or a composite material. An adhesive layer bonds the one of the opposed sides to the primary thermoplastic composite structure. A thermoplastic composite doubler plate is in contact with the other of the opposed sides of the secondary panel. The thermoplastic composite doubler plate has a depression formed therein that extends into the aperture. A weld fixedly attaches the thermoplastic composite doubler plate to the primary thermoplastic composite structure through the aperture. Methods for making a structural joint are also disclosed herein.

### CROSS-REFERENCE TO RELATED APPLICATIONS

This application claims the benefit of U.S. Patent Provisional Application Ser. No. 61/558,792, filed Nov. 11, 2011.

### TECHNICAL FIELD

The present disclosure relates generally to structural members and methods of making structural joints.

### BACKGROUND

Structural panels and joints are often used in the automotive industry. In one instance, a composite is sandwiched between two metal components. This metal-composite-metal configuration may be desirable, for example, when joining a composite floorpan of an automotive vehicle to a steel frame rail, dash-panel and rear floor of the vehicle. This metal-composite-metal configuration may also be desirable, for example, when joining a composite hood inner panel of an automotive vehicle to steel hinge reinforcements of the vehicle, etc.

### SUMMARY

Examples of structural members are disclosed herein. In an example, the structural member includes a primary thermoplastic composite structure and a secondary panel having opposed sides and an aperture extending from one of the opposed sides to another of the opposed sides. The secondary panel is formed of metal or a composite material. An adhesive layer bonds the one of the opposed sides to the primary thermoplastic composite structure. A thermoplastic composite doubler plate is in contact with the other of the opposed sides. The thermoplastic composite doubler plate has a depression formed therein that extends into the aperture. A weld fixedly attaches the thermoplastic composite doubler plate to the primary thermoplastic composite structure through the aperture. Methods for making structural joints are also disclosed herein.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a bottom, perspective, cut-away view of an example of a structural member including an example of a structural joint;

FIGS. 2A through 2C are exploded, perspective, cut-away views that illustrate examples of different apertures that may be formed in a secondary panel and complementary depressions that may be formed in a composite doubler plate of the structural members disclosed herein;

FIG. 3 is a cross-sectional exploded view of the structural member of FIG. 1;

FIG. 4 is a cross-sectional view of another example of the structural member; and

FIG. 5 is a cross-sectional view of another example of a structural member including another example of a structural joint.

### DETAILED DESCRIPTION

Some example(s) of the structural member and the structural joint disclosed herein include thermoplastic composites (e.g., a primary thermoplastic composite structure and a composite doubler plate) that are pin-jointed together with ultrasonic or vibrational welding. In general, weld bonding offers the advantage of forming a weld that holds the joint together as an adhesive used in the structural member cures. As such, the entire structure may be exposed to curing conditions without the use of external holding mechanisms, such as fixtures, clamps, or other machinery. In an example, the entire structural member may be positioned in an oven to cure the adhesive. Weld bonding also offers the advantage of forming a weld that provides peel-stoppers for the joint during use. In the final structural member, the weld provides a secondary structural joint in the event that the primary structural joint (i.e., the adhesive) fails.

Other example(s) of the structural member and the structural joint disclosed herein include at least one thermoset composite (e.g., a primary thermoset composite structure and/or a thermoset composite doubler plate) that are pin-jointed together with a mechanical pin-joint. Like weld bonding, the mechanical pin-joint offers the advantage of forming a joint that holds the components together as an adhesive used in the structural member cures. As such, the entire structure may be exposed to curing conditions without the use of external holding mechanisms, such as fixtures, clamps, or other machinery. The mechanical pin-joint also provides a peel-stopper for the joint during use.

The use of composite joining technology as described in the examples disclosed herein enables a cosmetic structure to be obtained. This is particularly desirable if the composite structure is to be highly or moderately visible to a customer in the final product. As an example, the structural member may include class-B surfaces, where the surfaces may be highly visible in the final product, or class-C surfaces, where the surfaces may be moderately visible in the final product. Both class-B and class-C surfaces are cosmetically acceptable, at least in part because these surfaces lack major aesthetic defects. The lack of major aesthetic defects may be due to the fact that thermoplastic welding or the methods of mechanical pin-jointing disclosed herein are minimally aggressive pin-jointing methods, and the resulting joint(s) can be painted. Examples of class-B surfaces in a vehicle include door openings and inner panels, and all exterior surfaces below the horizontal line to the top bumper level. Examples of class-C surfaces in a vehicle include the trunk lid inner and the tailgate inner.

The use of composites also reduces the overall weight and mass of the structural member (compared, for example, to a similar structural member formed with metal).

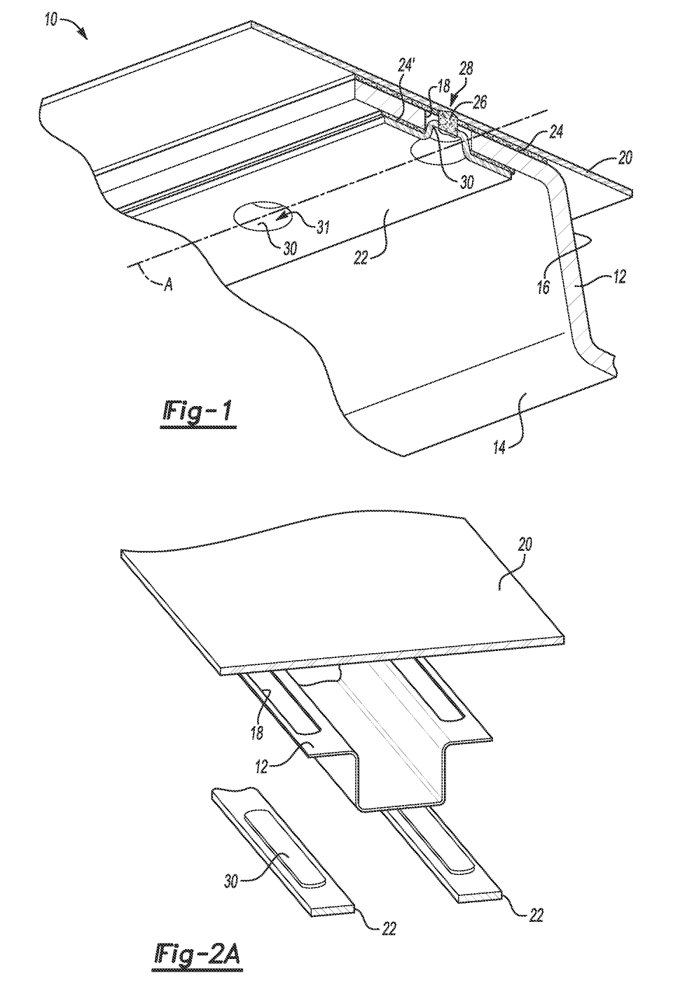

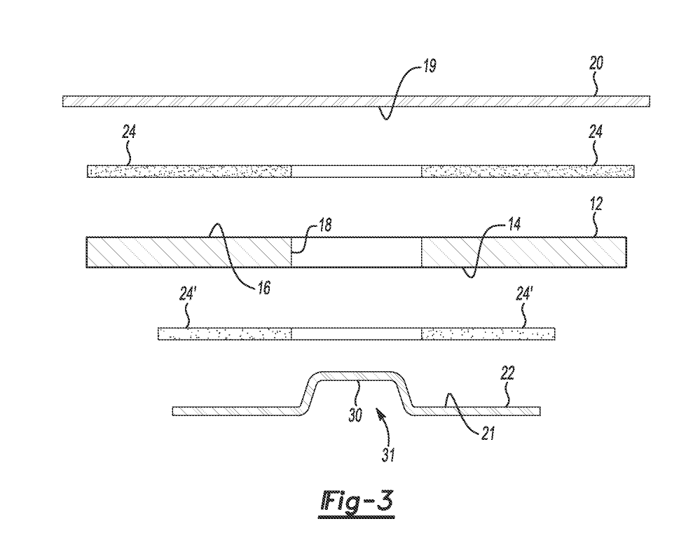

FIG. 1 illustrates an example of the structural member 10. Methods for forming the structural member 10 will be discussed in reference to FIG. 3. The example of the structural member 10 shown in FIG. 1 includes a panel 12 (i.e., secondary panel 12) that is formed of metal or a composite material. In an example, the panel 12 is made of any suitable metal, e.g., steel, aluminum, magnesium, etc., that may be used in automotive applications. When the panel 12 is formed of a composite material, it is to be understood that any thermoplastic or thermoset resin that is reinforced with fibers may be used. As examples, the resin may be epoxy resins, urethane resins, polyester resins, polyamide resins, or polyolefin resins (e.g., polyethylene resins, polypropylene resins, etc.), and the fibers may be glass fibers, carbon fibers, para-aramid synthetic fibers (e.g., KEVLAR® fibers), and/or natural fibers (examples of which include hemp, jute, kenaf, sisal, coir, and bamboo).

The secondary panel 12 has opposed sides 14, 16 and an aperture 18 extending therethrough. Any number of apertures 18 may be formed in the panel 12. In an example, the number and positioning of the apertures 18 is determined, at least in part, by a primary thermoplastic composite structure 20 and a composite doubler plate 22 that will sandwich the secondary panel 12 once the structural member 10 is formed. The apertures 18 may be formed during the initial manufacture of the secondary panel 12. For example, the apertures 18 may be cut or punched into the panel 12. As examples, the aperture(s) 18 may be formed via mechanical methods, such as drilling or punching, or via other suitable methods, such as waterjet cutting, laser cutting, etc.

In this example, both the primary thermoplastic composite structure 20 and the composite doubler plate 22 are formed of a synthetic thermoplastic composite material that is suitable for use in an automotive vehicle. The composites may be resin materials that are reinforced with glass fibers, carbon fibers, aramid fibers, para-aramid synthetic fibers (e.g., KEVLAR® fibers), and/or natural fibers (e.g., hemp, jute, kenaf, sisal, coir, and bamboo). Any of the fibers may be woven, chopped, continuous strand, mats, non-crimp fabrics, or unidirectional. In addition, the composites may be resin materials reinforced with nano-reinforcements, such as nano-graphene, graphite nano-fibers, or nano-clays, or internal reinforcements, such as crystalline polymer, or a combination of these reinforcements. Suitable resins include thermoplastics, such as polyamides, polyolefins (e.g., polypropylene), or polyphenylene sulfide.

Carbon fiber composites may be particularly desirable for the primary thermoplastic composite structure 20 and the composite doubler plate 22, at least in part because they are relatively stiff materials and can be made relatively thin (where stiffness and thickness depend, at least in part, on materials used and part geometry). While the primary thermoplastic composite structure 20 and the composite doubler plate 22 may be a reinforced thermoplastic, the primary thermoplastic composite structure 20 and doubler plate 22 may also be a non-reinforced thermoplastic resins.

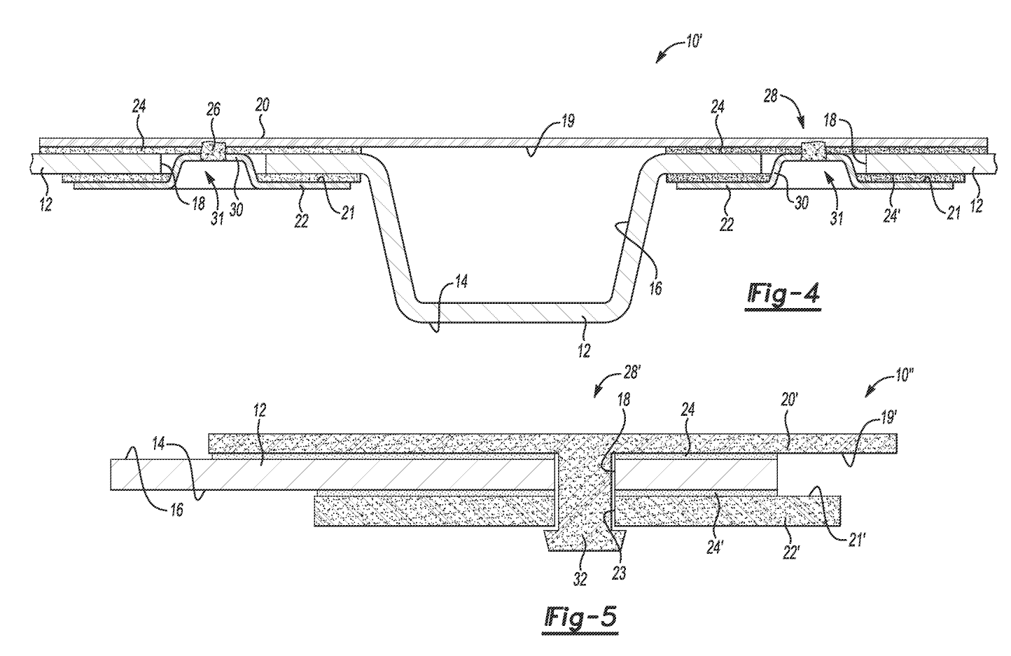

In the example shown in FIG. 1, the primary thermoplastic composite structure 20 is a structural composite rail configured to act as a load bearing member of a vehicle body. As examples, the primary thermoplastic composite structure 20 may be a liftgate or a door inner. An example of the liftgate primary thermoplastic composite structure 20 is described and shown in FIG. 4.

The primary thermoplastic composite structure 20 may be formed or shaped into the desired configuration using any suitable technique. Examples of suitable techniques include injection molding and compression molding. The technique used may depend, at least in part, on the material selected. For example, compression molding techniques may be applied to long fiber thermoplastics or fiber mat or fabric thermoplastics.

The primary thermoplastic composite structure 20 is adhesively bonded to the opposed side 16 of the secondary panel 12. The adhesive 24 is shown between the primary thermoplastic composite structure and the opposed side 16. In the example shown in FIG. 1, adhesive 24′ is also included between the composite doubler plate 22 and the other opposed side 14 of the secondary panel 12. In an example, adhesive 24′ is not positioned on the depression (see reference numeral 30) of the composite doubler plate 22. It is to be understood that in these instances, the adhesives 24, 24′ and a weld 26 (discussed below) fixedly attach the components 12, 20 and 22 together. In other instances, however, some examples of the structural member 10 do not include the adhesive 24′. In instances when adhesive 24′ is not included, the adhesive 24 and the weld 26 alone fixedly attach the components 12, 20 and 22 together. In still other instances, it is believed that adhesive 24′ may be used without the use of adhesive 24. It is to be understood that in these instances, the adhesive 24′ and the weld 26 fixedly attach the components 12, 20 and 22 together. This may be less desirable, for example, when the main structure is between components 12 and 20, and may be more desirable, for example, when the doubler plate 22 is also a structural component (as opposed to a reinforcement piece). In each of the instances discussed herein, it is to be understood that the adhesive(s) 24, 24′ is/are the primary structural joint(s) and the weld(s) 26 is/are the secondary structural joint(s).

The adhesives 24, 24′ may include an epoxy, urethane, acrylic, etc., applied, for example, as a tape, liquid, paste or pressure sensitive adhesive. One-part or two-part thermosets may be suitable, as well as hot melt thermoplastics. Examples of commercially available adhesives 24, 24′ include Dow BETAMATE™ (1-part epoxy adhesives); Dow BETAFORCE™ (2 component polyurethane adhesives), or ITW Plexus PLEXUS™ MA (2 part methacrylate adhesives). It is to be understood however, that any suitable adhesive may be used. The selection of a suitable adhesive may depend on the material selected for the primary thermoplastic composite structure 20 and/or composite doubler plate 22, the cost of the adhesive 24 and/or 24′, manufacturing constraints of processing the adhesive 24 and/or 24′, the intended use of the structural joint 28, etc. The adhesives 24, 24′ may be cured by heat, room-temperature chemical reaction, induction, or any other curing method. In the examples disclosed herein, the adhesive(s) 24 and/or 24′ carry the majority of the joint load. The adhesive(s) 24 and/or 24′ may be applied to have a thickness of at least 0.1 mm. In an example, the adhesive 24, 24′ thickness is up to 3 mm, and in some instances, the thickness is even greater. As an example, the thickness of the adhesive 24 and/or 24′ is about 0.8 mm.

As shown in FIG. 1, the composite doubler plate 22 is in contact with the opposed side 14 of the secondary panel 12. As used herein, it is to be understood that the phrase “composite doubler plate” refers to a piece or part that enables the joint 28 (or 28′ described below) to be formed. The composite doubler plate may be used for joining reinforcement or may be a separate structural part of the structural component 10. The composite doubler plate 22 has depression(s) 30 (i.e., dimples, divots, buttons, etc.) formed therein that extend into respective aperture(s) 18 of the secondary panel 12. The walls of the depression(s) 30 define an area 31 within the composite doubler plate 22 that is free of material. The area 31 is hollow, and thus the depression(s) 30 are not solid protrusions that are made up of the composite doubler plate material. The hollow depression(s) 30 may easily be formed in a panel or sheet structure (including one with long fibers). The hollow depression(s) 30 also provides a mass advantage, compared, for example, to solid protrusions.

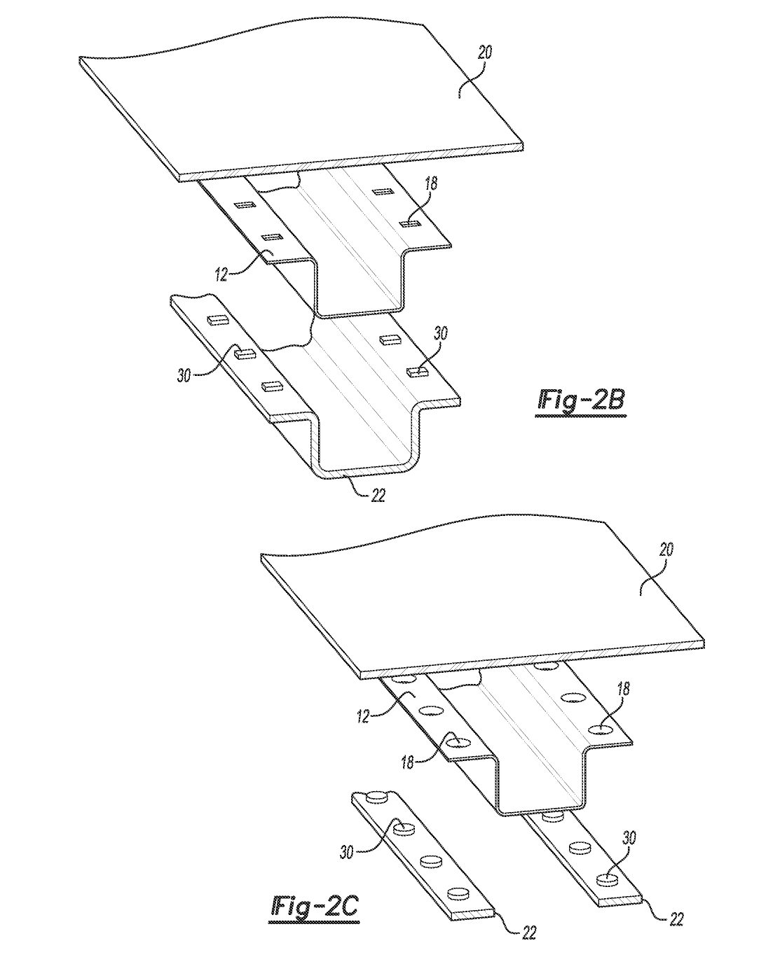

In some instances, as shown in FIG. 1, the aperture(s) 18 has/have a shape that is complementary to the shape of the depression(s) 30. In other instances, the aperture(s) 18 may have a shape that is non-complementary to the shape of the depression(s) 30. For example, the aperture(s) 18 may have a square shape, and the depression(s) 30 may have a conical shape. Example aperture 18 and corresponding depression 30 shapes are shown in FIGS. 2A-2C. In FIGS. 2A-2C, it is to be understood that the depressions 30 do define respective areas 31; however, these areas 31 are on the underside of the composite doubler plate 22 and thus are not visible in the views shown in FIGS. 2A-2C. Vibration or ultrasonic welding allows for different weld geometries beyond traditional spot weld design. As such, a variety of aperture 18 and/or depression 30 shapes may be used, such as rectangular slots and/or depressions extending in either the X direction or the Y direction, square slots and/or depressions, oval slots and/or depressions, or various combinations of the shapes.

The depression(s) 30 may be stamped or otherwise integrally formed with the composite doubler plate 22. In an example in which the composite doubler plate 22 is formed of a thermoplastic material, the depression(s) 30 may be formed via molding or may be stamped subsequent to molding. While not shown, it is to be understood that the depression(s) 30 may be formed in the primary thermoplastic composite structure 20 instead of in the composite doubler plate 22, or some depression(s) 30 may be formed in the composite doubler plate 22 at some locations and may be formed in the primary thermoplastic composite structure 20 at other locations. It is to be understood that doubler plate 22 may be formed from a single piece, e.g., as shown in FIG. 2B; or doubler plate 22 may be formed from multiple pieces, e.g., as shown in FIGS. 2A and 2C.

The depression(s) 30 may be formed so that portions of the composite doubler plate 22 lie flush against the secondary panel 12. For example, the depression(s) 30 and the immediately surrounding area of the plate 22 may have a depth approximately equal to the thickness of the secondary panel 12 plus the thickness of the adhesive layer(s) 24, 24′ used. The portions of the composite doubler plate 22 away from the depression(s) 30 may also be formed so that these portions are spaced away from the panel 12 to allow for attachment to another part, such as a wiring harness. It is to be understood that other configurations and arrangements are also within the purview of this disclosure. Additionally, the depression(s) 30 shown in FIG. 1 are sized relative to the aperture(s) 18 so as to provide a clearance fit. In other examples, the depression(s) 30 may be sized relative to the aperture(s) 18 so as to provide an interference fit.

The composite doubler plate 22 shown in FIG. 1 includes two depressions 30 positioned generally along an axis A. It is to be understood that a greater or fewer number of the depressions 30 may be used. In other examples, the depressions 30 may be positioned offset from one another, or positioned to form a grid or other desired pattern/layout. The depression placement may be determined, at least in part, by the geometry of the components 12, 20, 22.

In an example, at least a portion of each of the depression(s) 30 contacts and is welded, as discussed below, to the primary thermoplastic composite structure 20 through the aperture(s) 18. As mentioned above, the weld is shown at reference numeral 26 in FIG. 1.

The structural joint 28 shown in FIG. 1 is formed when the weld 26 is formed and the adhesive(s) 24, 24′ is/are cured. As shown in FIG. 1, the primary thermoplastic composite structure 20 and the composite doubler plate 22 are attached to the secondary panel 12 such that the aperture(s) 18 are covered and such that at least a portion of the secondary panel 12 surrounding the aperture(s) 18 is sandwiched between the primary thermoplastic composite structure 20 and the doubler plate 22.

While not shown, it is to be understood that gaps between the primary thermoplastic composite structure 20 and secondary panel 12 and/or between the doubler plate 22 and the secondary panel 12 may be controlled using glass beads, wires, stand-offs, etc. on any of the components 12, 20, 22.

Furthermore, it is to be understood that the primary thermoplastic composite structure 20, the doubler plate 22, and the secondary panel 12 may have any configuration suitable for the environment and/or intended use of the structural joint 28. For example, in examples where the primary thermoplastic composite structure 20 is curved, the composite doubler plate 22 and secondary panel 12 may also be formed with corresponding curves to mate with the primary thermoplastic composite structure 20.

Examples of the method for forming the structural member 10 will now be discussed in reference to FIG. 3.

In this example, the adhesive layer 24 is applied to one side (e.g., a mating surface 19) of the primary thermoplastic composite structure 20 and/or the side 16 of the secondary panel 12. The mating surface 19 of the primary thermoplastic composite structure 20 is then placed into contact with the side 16 of the secondary panel 12. Also in this example, the adhesive layer 24′ is applied to one side (e.g., a mating surface 21) of the composite doubler plate 22 and/or the side 14 of the secondary panel 12. Once the adhesive 24′ is applied, the composite doubler plate 22 is positioned relative to the secondary panel 12 such that the depression(s) 30 are in registration with respective aperture(s) 18, and then the mating surface 19 of the composite doubler plate 22 is placed into contact with side 14 of the secondary panel 12. When the adhesive 24′ is applied to the composite doubler plate 22, it is to be understood that the surfaces of the depression 30 do not have adhesive 24′ applied thereto. If adhesive 24′ is inadvertently applied to the depression 30, the adhesive 24′ may be cleaned off or otherwise removed. As such, it is to be understood that adhesive 24′ is generally not positioned on the depression(s) 30. Furthermore, at this point in the method, the adhesives 24, 24′ are in contact with the primary thermoplastic composite structure 20, the composite doubler plate 22, and the secondary panel 12, but are, in most instances, not yet cured.

The adhesive(s) 24, 24′ may be applied by hand (e.g., with a spatula or other suitable tool), a hand-operated dispensing system, or a robotically-operated dispensing system.

A vibration or ultrasonic weld or other heat-staking operation (shown as weld 26 in FIG. 1) is then formed to fixedly attach the depression(s) 30 of the composite doubler plate 22 to the primary thermoplastic composite structure 20. Welding may be accomplished via vibration welding or ultrasonic welding. When the secondary panel 12 is formed of a thermoplastic composite, it may be desirable to use vibration welding. The weld 26 provides a localized joint which fastens the composite doubler plate 22 to the primary thermoplastic composite structure 20 through the aperture 18 of the secondary panel 12.

Once welding is performed, the adhesive layer(s) 24, 24′ is/are then cured. A hot melt adhesive will set/cure, forming a bond, over a predetermined time which depends upon the material used, in the ambient environment. A pressure-sensitive adhesive may also need time to develop full strength. Other adhesive layers 24, 24′ may be cured via exothermic methods, including heat, light, induction or electron-beam (e-beam) radiation curing. The mechanism used for curing will depend upon the adhesive used. Curing bonds the secondary panel 12 with the primary thermoplastic composite structure 20 and the doubler plate 22.

It is to be understood that because the weld 26 fixedly attaches the depression(s) 30 to the primary thermoplastic composite structure 20 prior to setting or curing, external means for holding the composite doubler plate 22 and primary thermoplastic composite structure 20 in place relative to one another during setting or curing are not necessary. As such, the entire structure may be exposed to curing conditions (e.g., placed in an oven or under a lamp) without clamps, fixtures, etc. holding the pieces 12, 20, 22 together.

It is to be understood that in other examples of the method, the adhesive layer 24′ may first be applied to one or both of the side 14 of the secondary panel 12 and the composite doubler plate 22 (except at the depression(s) 30). In this example, the composite doubler plate 22 may then be positioned relative to the secondary panel 12 such that the depression(s) 30 are aligned with respective aperture(s) 18. The composite doubler plate 22 may then be moved into contact with the secondary panel 12. In this example of the method, the adhesive layer 24 may then be applied to either or both of the primary thermoplastic composite structure 20 or the side 16 of the secondary panel 12. The primary thermoplastic composite structure 20 is then placed into contact with the side 16 of the secondary panel 12. Welding and curing may be accomplished as previously described to form the structural joint 28.

In still other examples of the method, both of the adhesive layers 24, 24′ may be applied at the same time prior to fixedly attaching and setting or curing. In still other examples of the method, it is to be understood that the method(s) described above may be performed using adhesive 24 alone, or using adhesive 24′ alone.

Referring now to FIG. 4, another example of the structural member 10′ is depicted. In this example, the primary thermoplastic composite structure 20 may be a composite inner panel of a lift gate (e.g., for a sport utility vehicle) that is joined to the secondary panel 12, which may be a steel cross member (e.g., the interior part of the lift gate holding a window glass frame or the lift gate lock mechanism). In this example, a structural joint 28 is formed at the respective flanges of the steel cross member. The secondary panel 12 or steel cross member is fixedly attached (via the adhesives 24, 24′ and the weld 26) between the primary thermoplastic composite structure 20 (in this example, the composite lift gate inner panel) and the composite doubler plate 22.

While the previous discussion is directed to the use of thermoplastic materials as the primary structure 20 and the composite doubler plate 22, in another example, the primary structure 20′ and/or the composite doubler plate 22′ may be formed of a thermoset material instead of a thermoplastic material. Examples of suitable thermoset materials include thermoset resins, such as epoxies, vinyl ester, polyester, or urethanes, any of which may be reinforced with the fibers or nano-reinforcements described herein.

An example of a structural member 10″ including a thermoset primary structure 20′ and a thermoset composite doubler plate 22′ is shown in FIG. 5. As illustrated, in some examples, the composite doubler plate 22′ and the primary structure 20′ are formed of a reinforced thermoset. In other examples, the primary structure 20′ is formed of a reinforced thermoset and the composite doubler plate 22′ is formed of a reinforced thermoplastic. In still other examples, the composite doubler plate 22′ is formed of a reinforced thermoset and the primary structure 20′ is formed of a reinforced thermoplastic.

It is to be understood that when either or both of the primary structure 20′ and the composite doubler plate 22′ are formed of a thermoset, the materials 20′ and 22′ may be pin-jointed using a mechanical pin-joint 32 rather than the weld(s) 26 previously described. As an example, a snap-fit may be used in place of the weld 26. The mechanical pin-joints 32 will be described further hereinbelow.

As shown in FIG. 5, the structural member 10″ includes the secondary panel 12 previously described, as well as the primary structure 20′, and the composite doubler plate 22′.

The primary composite structure 20′ may be formed or shaped into the desired configuration using any suitable technique. Examples of suitable techniques include reaction injection molding, structural reaction injection molding, and compression molding. The technique used may depend, at least in part, on the material selected.

As shown in FIG. 5, the mechanical pin-joint 32 may be integrally formed with the primary composite structure 20′. This may be particularly desirable when the mechanical pin-joint 32 is a snap-fit projection and the primary composite structure 20′ is formed of the reinforced thermoset. In an example, the primary composite structure 20′ is a glass-fabric reinforced sheet molding compound (SMC) that is compression molded. The snap-fit mechanical pin-joint 32 may be formed by adding short-glass sheet molding compound to the SMC charge before molding the primary composite structure 20′. During this type of process, molding die-lock may be prevented by a variety of methods, including by altering the shape and/or configuration of the snap-fit mechanical pin-joint 32. In another example, the snap-fit mechanical pin-joint 32 may be a metallic, polymeric, or composite piece that is insert-molded into the primary composite structure 20′.

The primary composite structure 20′ may be adhesively bonded to the opposed side 16 of the secondary panel 12. The adhesive 24 is shown between the primary composite structure 20′ and the opposed side 16. In the example shown in FIG. 5, adhesive 24′ is also included between the composite doubler plate 22′ and the other opposed side 14 of the secondary panel 12. It is to be understood that in these instances, the adhesives 24, 24′ and the mechanical pin-joint 32 fixedly attach the components 12, 20′ and 22′ together. In other instances, however, some examples of the structural member 10″ do not include the adhesive 24′. In still other instances, it is believed that adhesive 24′ may be used without the use of adhesive 24 (this example may be more desirable when the composite doubler plate 22′ is also a structural component). In each of the instances discussed herein, it is to be understood that the adhesive(s) 24, 24′ is/are the primary structural joint(s) and the mechanical pin-joints 32 is/are the secondary structural joint(s).

The adhesives 24, 24′ may be any of the adhesives previously described herein, and may be cured via any of the methods described herein.

As shown in FIG. 5, the composite doubler plate 22′ is in contact with the opposed side 14 of the secondary panel 12. This example of the composite doubler plate 22′ has an aperture 23 formed therein that is at least partially aligned with the aperture 18 of the secondary panel 12 so that the mechanical pin-joint 32 may be inserted through the apertures 18, 23 in order to form a joint 28 that attaches the parts/pieces 20′, 12, 22′ together. In this example, the apertures 18, 23 may have any desirable size and/or shape that is/are capable of receiving the selected mechanical pin-joint 32.

The composite doubler plate 22′ shown in FIG. 5 includes a single aperture 23. It is to be understood that any number of apertures 23 may be used. The apertures 23 may be along the same axis, or positioned offset from one another, or positioned to form a grid or other desired pattern/layout. The apertures 23 placement may be determined, at least in part, by the geometry of the components 12, 20′, 22′ and the aperture(s) 18 in the secondary panel 12, and the load overall requirements of the structure 10″ and the joint 28″.

The composite doubler plate 22′ may be formed from a single piece, e.g., as shown in FIG. 5; or the composite doubler plate 22′ may be formed from multiple pieces.

The structural joint 28′ shown in FIG. 5 is formed when the mechanical pin-joint 32 is secured in place through the apertures 18, 23 and the adhesive(s) 24, 24′ is/are cured. As previously mentioned, the mechanical pin-joint 32 may be a snap-fit projection. The snap-fit projection may be either solid or hollow, and may be a single piece or multiple pieces. As an example, a multi-piece snap-fit projection may be a cylindrical projection that is cut into two or more pieces along an axis that is perpendicular to the diameter of the cylinder.

While not shown, it is to be understood that gaps between the primary composite structure 20′ and secondary panel 12 and/or between the doubler plate 22′ and the secondary panel 12 may be controlled using glass beads, wires, stand-offs, etc. on any of the components 12, 20′, 22′.

Furthermore, it is to be understood that the primary composite structure 20′, the doubler plate 22′, and the secondary panel 12 may have any configuration suitable for the environment and/or intended use of the structural joint 28′. For example, in examples where the primary composite structure 20′ is curved, the composite doubler plate 22′ and secondary panel 12 may also be formed with corresponding curves to mate with the primary composite structure 20′.

When making the structural member 10″ shown in FIG. 5, the adhesive layer 24′ is applied to one side (e.g., a mating surface 21′) of the composite doubler plate 22′ and/or the side 14 of the secondary panel 12. Once the adhesive 24′ is applied, the composite doubler plate 22′ is positioned relative to the secondary panel 12 such that the apertures 18 and 23 are in registration with each other. In this example, the adhesive layer 24 is then applied to one side (e.g., a mating surface 19′) of the primary composite structure 20′ and/or the side 16 of the secondary panel 12. The mechanical pin-joint 32 is then aligned with the apertures 18 and 23, and the mating surface 19′ of the primary composite structure 20 is then placed into contact with the side 16 of the secondary panel 12. The mechanical pin-joint 32 is pushed through the apertures 18, 23 until the mechanical pin-joint 32 snaps into place. It is to be understood that the adhesives 24, 24′ may be applied in a different order if that is desirable.

Once the mechanical pin-joint 32 in securely in place, the adhesive layer(s) 24, 24′ is/are then cured. Curing may be performed as previously described. Curing bonds the secondary panel 12 with the primary composite structure 20′ and the doubler plate 22′.

It is to be understood that because the mechanical pin-joint 32 fixedly attaches the parts/pieces 20′, 12, 22′ prior to setting or curing, external means for holding the composite doubler plate 22′ and primary composite structure 20′ in place relative to one another during setting or curing are not necessary. As such, the entire structure may be exposed to curing conditions (e.g., placed in an oven or under a lamp) without clamps, fixtures, etc. holding the pieces 12, 20′, 22′ together.

The structural members 10, 10′, 10″ including the structural joint(s) 28, 28′ may be used in a variety of other applications as well. Examples of other applications may include joining of thermoplastic components, such as the wheelhouse inner, or the dash panel, or the engine cover surround in a full size van to the steel vehicle frame; joining of a thermoplastic spare tire bin to a composite trunk structure; joining of thermoplastic knee bolsters or the glove box to a steel or composite instrument panel; or joining of a steel transmission tunnel to thermoplastic floorpan side segments; or the like. The structural members 10, 10′ may also be used in an electric vehicle to form a battery tray or enclosure that is formed in the interior of the vehicle (e.g., on an arm rest or a center console) and is joined to steel members of the vehicle. In still another example, the structural members 10, 10′, 10″ may be utilized in a rocker section/panel of a vehicle door. For example, the rocker may be a composite material that is joined to a steel underbody or cross-member, or to a metallic reinforcement member. The structural members 10, 10′, 10″ may be used in non-automotive applications as well, including in wind turbines, aerospace applications, marine applications, construction and infrastructure (e.g., composite bridges, walkways, or the like), etc.

It is to be understood that the ranges provided herein include the stated range and any value or sub-range within the stated range. For example, a range of up to 3 mm should be interpreted to include not only the explicitly recited limit of 3 mm, but also to include individual values, such as 0.25 mm, 0.5 mm, 2 mm, etc., and sub-ranges, such as from about 0.5 mm to about 2.5 mm, from about 0.7 mm to about 2.9 mm, etc. Furthermore, when “about” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

While several examples have been described, it will be apparent to those skilled in the art that the disclosed examples may be modified. Therefore, the foregoing description is to be considered non-limiting.

1. A structural member, comprising:
a primary thermoplastic composite structure;
a secondary panel having opposed sides and an aperture extending from one of the opposed sides to an other of the opposed sides, the secondary panel being formed of metal or a composite material;
an adhesive layer bonding the one of the opposed sides to the primary thermoplastic composite structure;
a thermoplastic composite doubler plate in contact with the other of the opposed sides, the thermoplastic composite doubler plate having a depression formed therein that extends into the aperture; and
a weld fixedly attaching the thermoplastic composite doubler plate to the primary thermoplastic composite structure through the aperture.

2. The structural member as defined in claim 1 wherein the depression defines an indented area in the thermoplastic composite doubler plate that is free of material.

3. The structural member as defined in claim 1 wherein the aperture and the depression each have a round shape, a rectangular shape, a square shape, or an oval shape.

4. The structural member as defined in claim 1 wherein the primary thermoplastic composite structure and the thermoplastic composite doubler plate are each formed of a resin material that is reinforced with carbons fibers, glass fibers, combinations of carbon and glass fibers, para-aramid synthetic fibers, natural fibers or nano-reinforcements.

5. The structural member as defined in claim 1, further comprising an other adhesive layer bonding the thermoplastic composite doubler plate to the other of the opposed sides.

6. The structural member as defined in claim 5 wherein the depression is free of the other adhesive layer.

7. The structural member as defined in claim 1 wherein the weld is an ultrasonic weld or a vibration weld.

8. The structural member as defined in claim 1 wherein the secondary panel is a steel cross member or a non-steel metal cross member.

9. A method for making a structural joint, comprising:
applying an adhesive to i) a side of a primary thermoplastic composite structure, or ii) one of two opposed sides of a secondary panel formed of metal or a composite material, or iii) both the side of the primary thermoplastic composite structure and the one opposed side of the secondary panel;
placing the side of the primary thermoplastic composite structure in contact with the one opposed side of the secondary panel;
positioning a depression formed in a thermoplastic composite doubler plate within an aperture of the secondary panel such that a side of the thermoplastic composite doubler plate is adjacent to an other of the two opposed sides of the secondary panel;
welding the depression of the thermoplastic composite doubler plate to the primary thermoplastic composite structure so that the thermoplastic composite doubler plate and the primary thermoplastic composite structure are fastened together through the aperture of the secondary panel; and
curing the adhesive.

10. The method as defined in claim 9 wherein prior to positioning the depression within the aperture, the method further comprises applying the adhesive to i) the side of the thermoplastic composite doubler plate, or ii) the other of the two opposed sides of the secondary panel, or iii) both the side of the thermoplastic composite doubler plate and the other of the two opposed sides of the secondary panel.

11. The method as defined in claim 10, further comprising applying the adhesive to i) the side of the thermoplastic composite doubler plate, or ii) the other of the two opposed sides of the secondary panel, or iii) both the side of the thermoplastic composite doubler plate and the other of the two opposed sides of the secondary panel prior to applying the adhesive to i) the side of the primary thermoplastic composite structure, or ii) the one opposed side of the secondary panel, or iii) both the side of the primary thermoplastic composite structure and the one opposed side of the secondary panel.

12. The method as defined in claim 9 wherein welding is accomplished via vibration welding or ultrasonic welding.

13. The method as defined in claim 9 wherein curing is accomplished without an external mechanism holding the thermoplastic composite doubler plate and the primary thermoplastic composite structure together.

14. The method as defined in claim 9 wherein curing is accomplished using heat, room-temperature chemical reaction, light, e-beam radiation, or induction.

15. A structural member, comprising:
a primary composite structure;
a secondary panel having opposed sides and a secondary panel aperture extending from one of the opposed sides to an other of the opposed sides, the secondary panel being formed of metal or a composite material;
a composite doubler plate in contact with the other of the opposed sides, the composite doubler plate having a composite doubler plate aperture formed therein that corresponds with the secondary panel aperture; and
a mechanical pin-joint fixedly attaching the composite doubler plate to the primary composite structure through the secondary panel aperture and the composite doubler plate aperture;
wherein the primary composite structure or the composite doubler plate is formed of a thermoset material.

16. The structural member as defined in claim 15, further comprising an adhesive layer bonding the one of the opposed sides to the primary composite structure.

17. The structural member as defined in claim 15 wherein both the primary composite structure and the composite doubler plate are formed of the thermoset material.

18. The structural member as defined in claim 15 wherein the mechanical pin-joint is a snap-fit that is integrally formed with the primary composite structure.

19. The structural member as defined in claim 15 wherein the primary composite structure is formed of the thermoset material and the composite doubler plate is formed of a thermoplastic material.

20. The structural member as defined in claim 15 wherein the composite doubler plate is formed of the thermoset material and the primary composite structure is formed of a thermoplastic material.
